(19) United States
(12) Patent Application Publication
(10) Pub. No.: US 2017/0274775 A1
(43) Pub. Date: Sep. 28, 2017

(54) VEHICLE TRAVEL CONTROL DEVICE AND VEHICLE TRAVELING DEVICE

(71) Applicant: KEIHIN CORPORATION, Tokyo (JP)

(72) Inventor: Seiji KAMATA, Utsunomiya-shi (JP)

(21) Appl. No.: 15/433,434

(22) Filed: Feb. 15, 2017

(30) Foreign Application Priority Data
Mar. 25, 2016 (JP) 2016-062223

(51) Int. Cl. B60L 3/00; H01M 10/48

(52) U.S. Cl. CPC B60L 3/0046; H01M 10/486; H01M 10/482; H01M 2220/20; H01M 2010/4271

(57) ABSTRACT

A vehicle travel control device is provided for controlling traveling of a vehicle by controlling a travel driving device that drives a traveling motor with power of a battery assembly, wherein, when an abnormality has occurred in a battery monitoring device that monitors a state of the battery assembly, time-series changes of a remaining capacity are calculated on the basis of a remaining capacity of the battery assembly at a time of the occurrence of the abnormality and a battery current of the battery assembly after the occurrence of the abnormality, and the travel driving device is controlled on the basis of the remaining capacity obtained by the calculation.

### CROSS-REFERENCE TO RELATED APPLICATION

The present invention claims priority under 35 U.S.C. §119 to Japanese Application No. 2016-062223, filed Mar. 25, 2016, the entire content of which is incorporated herein by reference.

### BACKGROUND OF THE INVENTION

Field of the Invention

The present invention relates to a vehicle travel control device and a vehicle traveling device.

Description of Related Art

In Japanese Unexamined Patent Application, First Publication No. 2014-017901, a technology is disclosed in which a monitoring microcomputer determines a traveling time based on the remaining capacity of a battery assembly without stopping power supply from the battery assembly when it is determined that an abnormality has occurred in a control microcomputer and continues the driving of a traveling electric motor using a remaining capacity of the battery assembly by continuing the power supply from the battery assembly until the traveling time has elapsed.

### SUMMARY OF THE INVENTION

In the above-described conventional technology, the traveling electric motor is driven on the basis of the remaining capacity of the battery assembly acquired by the monitoring microcomputer at a time of an occurrence of an abnormality of the control microcomputer, but it is impossible to sufficiently effectively utilize the remaining capacity of the battery assembly when the traveling electric motor is driven on the basis of only the remaining capacity of the battery assembly at the time of the occurrence of the abnormality of the control microcomputer because the battery assembly is discharged and also charged according to a traveling state of the vehicle. That is, in the above-described conventional technology, the remaining capacity of the battery assembly is not sufficiently effectively utilized because a state in which the driving of the traveling electric motor is stopped may occur before the remaining capacity of the battery assembly reaches zero.

An aspect according to the present invention has been made in view of the above-described circumstances, and an objective of the aspect is to utilize a remaining capacity of a battery assembly more effectively than in the conventional technology.

To achieve the above-described objective, the present invention adopts the following aspects.
(1) A vehicle travel control device of an aspect of the present invention is a vehicle travel control device for controlling traveling of a vehicle by controlling a travel driving device that drives a traveling motor with power of a battery assembly, wherein, when an abnormality has occurred in a battery monitoring device that monitors a state of the battery assembly, time-series changes of a remaining capacity are calculated on the basis of a remaining capacity of the battery assembly at a time of the occurrence of the abnormality and a battery current of the battery assembly after the occurrence of the abnormality, and the travel driving device is controlled on the basis of the remaining capacity obtained by the calculation.
(2) In the above-described aspect (1), overcharging of the battery assembly may be monitored on the basis of the remaining capacity of the battery assembly at the time of the occurrence of the abnormality and the battery current of the battery assembly after the occurrence of the abnormality, and the traveling of the vehicle may be stopped before overcharging is reached.
(3) In the above-described aspect (1) or (2), a temperature of the battery assembly may be acquired and the travel driving device may be controlled on the basis of the remaining capacity of the battery assembly at the time of the occurrence of the abnormality and the battery current of the battery assembly after the occurrence of the abnormality and the temperature of the battery assembly.
(4) In the above-described aspect (2) or (3), a temperature of the battery assembly may be acquired and the overcharging of the battery assembly may be monitored on the basis of the remaining capacity of the battery assembly at the time of the occurrence of the abnormality and the battery current of the battery assembly after the occurrence of the abnormality and the temperature of the battery assembly.
(5) A vehicle traveling device of an aspect of the present invention is a vehicle traveling device including: a battery assembly; a traveling motor configured to drive a vehicle; a travel driving device configured to drive the traveling motor with power of the battery assembly; a battery monitoring device configured to monitor a state of the battery assembly; and the vehicle travel control device of any one of the above-described aspects (1) to (4) configured to control the travel driving device.

According to an aspect of the present invention, the remaining capacity of a battery assembly is utilized more effectively than in the conventional technology because, when an abnormality has occurred in a battery monitoring device that monitors a state of a battery assembly, time-series changes of a remaining capacity are calculated on the basis of a remaining capacity of the battery assembly at the time of the occurrence of the abnormality and a battery current of the battery assembly after the occurrence of the abnormality and the travel driving device is controlled on the basis of the remaining capacity obtained by the calculation.

### BRIEF DESCRIPTION OF THE DRAWINGS

FIG. 1 is a block diagram illustrating a configuration of a vehicle traveling device A according to an embodiment of the present invention.

FIG. 2 is a flowchart illustrating an operation of a vehicle travel control device 6 according to an embodiment of the present invention.

FIG. 3 is a characteristics diagram illustrating an operation of the vehicle travel control device 6 according to an embodiment of the present invention.

### DETAILED DESCRIPTION OF THE INVENTION

Hereinafter, an embodiment of the present invention will be described with reference to the drawings.

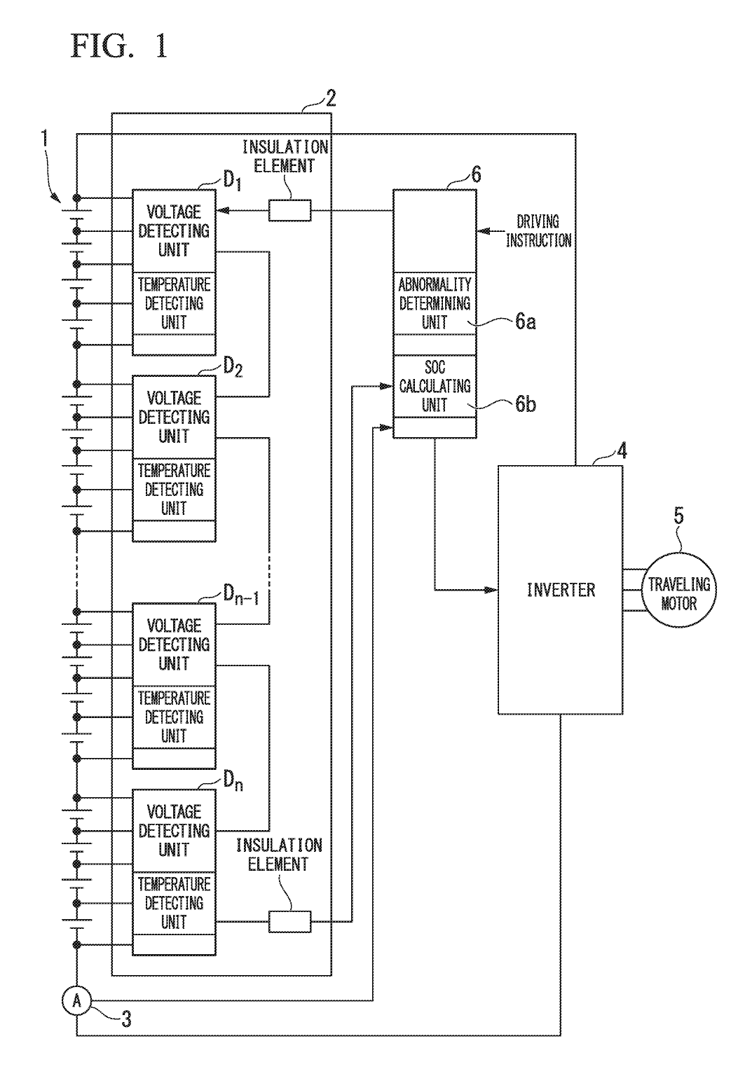

As illustrated in FIG. 1, a vehicle traveling device A according to the present embodiment includes a battery assembly 1, a voltage detecting device 2, an ammeter 3, an inverter 4 (a travel driving device), a traveling motor 5, and a vehicle travel control device 6.

The battery assembly 1 is constituted of a plurality of battery cells connected in series as illustrated and outputs a direct current (DC) of a predetermined voltage to the inverter 4. The voltage detecting device 2 detects a voltage (cell voltage Vs) and a temperature (cell temperature Ts) of each battery cell described above and is constituted of n (n: natural number) cell voltage detecting units D1 to Dn. The cell voltage detecting units D1 to Dn correspond to four battery cells as illustrated and detect cell voltages Vs and cell temperatures Ts of the four battery cells.

In addition, the cell voltage detecting units D1 to Dn are connected to one another as a so-called daisy chain type as illustrated. That is, the cell voltage detecting units D1 to Dn−1 output the cell voltages Vs and the cell temperatures Ts detected by the cell voltage detecting units D1 to Dn−1 to the cell voltage detecting units D2 to Dn of lower voltage sides, and the cell voltage detecting units D2 to Dn−1 of the lower voltage sides output the cell voltage Vs and the cell temperatures Ts supplied from the voltage detecting units D1 to Dn−2 of higher voltage sides to the cell voltage detecting units D3 to Dn−1 of lower voltage sides in addition to the cell voltages Vs and the cell temperatures Ts detected by the cell voltage detecting units D2 to Dn.

In addition, the cell voltage detecting unit D1 of a highest voltage side outputs the cell voltage Vs and the cell temperature Ts to the cell voltage detecting unit D2 adjacent to the lower voltage side on the basis of a transmission instruction signal input from the vehicle travel control device 6. In addition, the cell voltage detecting unit Dn of the lowest voltage side outputs the cell voltages Vs and the cell temperatures Ts of the cell voltage detecting units D1 to Dn−1 input from the cell voltage detecting unit Dn−1 adjacent to the higher voltage side to the vehicle travel control device 6 as voltage detection signals along with the cell voltage and the cell temperature detected by the cell voltage detecting unit Dn.

In addition, the cell voltage detecting units D1 to Dn and the vehicle travel control device 6 are operated by different power supplies. In this relationship, an insulation element for insulating the power supply is inserted into each of a transmission line for transmitting the above-described transmission instruction signal between the cell voltage detecting unit D1 and the vehicle travel control device 6 and a transmission line for transmitting the above-described voltage detection signal between the cell voltage detecting unit Dn and the vehicle travel control device 6. Each insulation element is, for example, a photocoupler.

That is, when the transmission instruction signal is input from the vehicle travel control device 6 to the cell voltage detecting unit D1 of the highest voltage side in the voltage detecting device 2, the cell voltages Vs and the cell temperatures Ts are sequentially output to the cell voltage detecting units D2 to Dn of the lower voltage sides and the cell voltages Vs and the cell temperatures Ts of all the cell voltage detecting units D1 to Dn, i.e., the cell voltages Vs and the cell temperatures Ts related to all the battery cells of the battery assembly 1, are finally output to the vehicle travel control device 6.

The ammeter 3 detects a battery current Id supplied from the battery assembly 1 to the inverter 4 and outputs the detected battery current Id as a current detection signal to the vehicle travel control device 6. The inverter 4 is a travel driving device that converts DC power supplied from the battery assembly 1 into alternating current (AC) power of a predetermined number of phases and supplies the AC power to the traveling motor 5. That is, the inverter 4 includes a number of switch legs equal to that of phases of the traveling motor 5 and adjusts a voltage amplitude of AC power (an operation signal) of each phase according to a duty ratio of a pulse-width modulation (PWM) signal (a control signal) input from the vehicle travel control device 6.

The traveling motor 5 is an electric motor of a predetermined number of phases, for example, a three-phase DC electric motor, to be driven by the AC power of each phase input from the above-described inverter 4. The traveling motor 5 generates a rotational torque corresponding to an AC power of each phase and rotationally drives wheels provided on the vehicle using the rotational torque.

The vehicle travel control device 6 is a software control device that exerts a predetermined control function by executing a control program stored therein, and includes a calculation device, a storage device, various interface circuits, and the like. The vehicle travel control device 6 controls the traveling of the vehicle by directly controlling the inverter 4 by setting the duty ratio of the above-described PWM signal according to a driving instruction of a driver.

In addition, the vehicle travel control device 6 includes an abnormality determining unit 6a and a state-of-charge (SOC) calculating unit 6b as functional components based on the above-described control function. The abnormality determining unit 6a determines normality/abnormality of the battery assembly 1 on the basis of the cell voltage Vs and the cell temperature Ts of the battery assembly 1 input from the voltage detecting device 2. The SOC calculating unit 6b calculates the SOC of the battery assembly 1 as a remaining capacity on the basis of the battery current Id input from the ammeter 3 in addition to the cell voltage Vs and the cell temperature Ts of the battery assembly 1 input from the voltage detecting device 2.

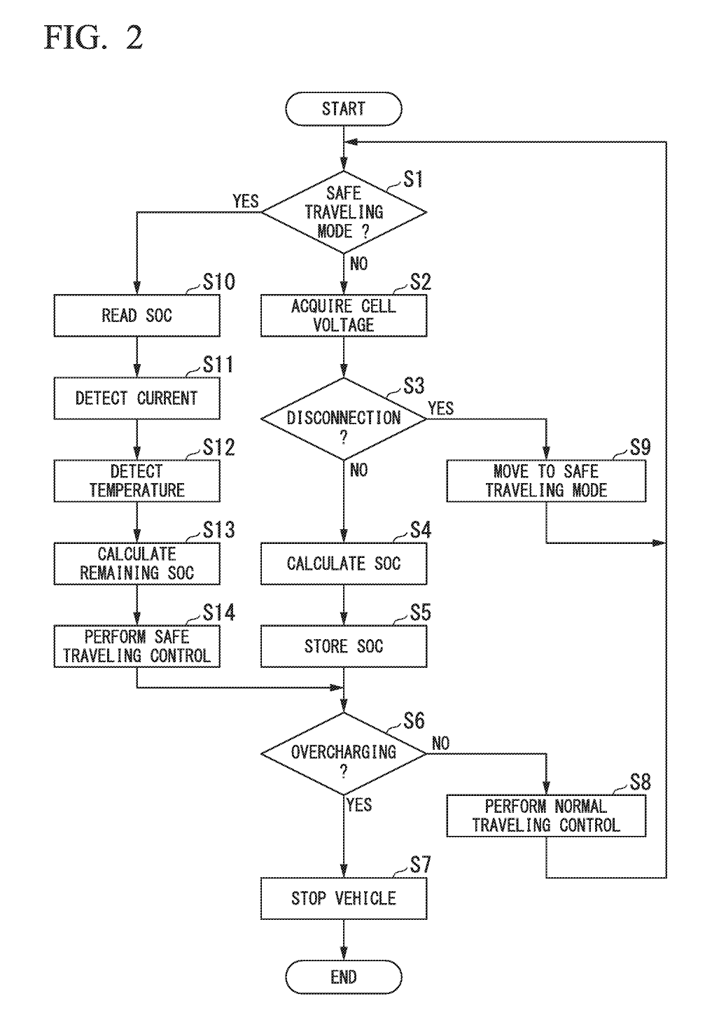

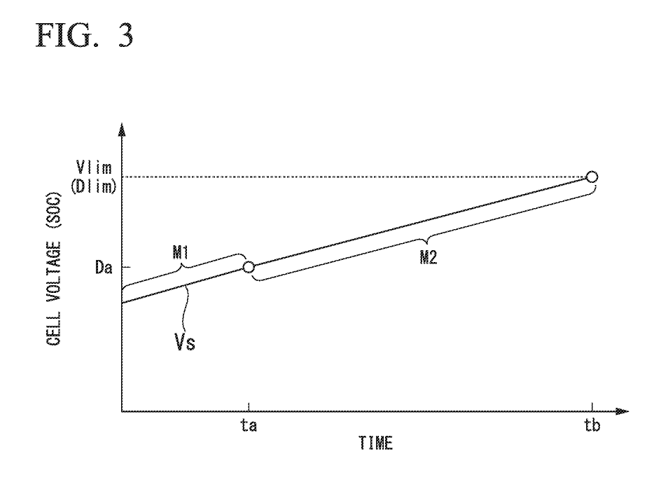

Next, an operation of the vehicle traveling device A according to the present embodiment will be described with reference to FIGS. 2 and 3.

In the vehicle traveling device A according to the present embodiment, when the voltage detecting device 2 is normal, the vehicle travel control device 6 controls the inverter 4 in a normal traveling mode M1 (normal traveling control). That is, in the normal traveling mode M1, the vehicle travel control device 6 sets the duty ratio of the PWM signal output to the inverter 4 exclusively according to the driver's driving instruction.

On the other hand, when any abnormality has occurred in the voltage detecting device 2, the vehicle travel control device 6 controls the inverter 4 in the safe traveling mode M2 instead of the normal traveling control. That is, the vehicle travel control device 6 performs travel control (safe traveling control) according to the remaining capacity (SOC) of the battery assembly 1 in addition to the driver's driving instruction in the safe traveling mode M2. Hereinafter, details of the above-described normal traveling control and safe traveling control will be described using the flowchart of FIG. 2.

First, the vehicle travel control device 6 determines whether the travel mode is set to the normal traveling mode M1 or the safe traveling mode M2 by checking an internal flag (step S1). Then, the vehicle travel control device 6 performs the process of step S2 when the travel mode is the normal traveling mode M1 and performs the process of step S9 when the travel mode is the safe traveling mode M2.

For example, when the determination of the above-described step S1 is the normal traveling mode M1, the vehicle travel control device 6 acquires the cell voltage Vs of each of the cell voltage detecting units D1 to Dn by outputting a transmission instruction signal to the voltage detecting device 2 (step S2). Then, it is determined whether or not an abnormality of the voltage detecting device 2, for example, a disconnection of the voltage transmission line connecting the battery cells and the cell voltage detecting units D1 to Dn, has occurred on the basis of the cell voltages Vs of the cell voltage detecting units D1 to Dn (step S3).

The technology disclosed in Japanese Unexamined Patent Application, First Publication No. 2013-085354 can be applied to the determination process of step S3.

Then, when the determination result of step S3 is “No,” i.e., when no abnormality has occurred in the voltage detecting device 2, the vehicle travel control device 6 calculates the SOC value of the battery assembly 1 on the basis of the cell voltages Vs of the cell voltage detecting units D1 to Dn (step S4) and stores the SOC value in the internal memory (step S5).

Then, the vehicle travel control device 6 determines whether or not the battery assembly 1 is reaching the overcharged state on the basis of the cell voltages Vs of the above-described cell voltage detecting units D1 to Dn (step S6). When the determination of step S6 is “Yes,” i.e., a state immediately before the battery assembly 1 reaches the overcharged state, the vehicle travel control device 6 stops the supply of the PWM signal to the inverter 4 to stop the vehicle and prevents the battery assembly 1 from reaching the overcharged state.

Here, the vehicle travel control device 6 determines whether or not the battery assembly 1 is reaching the overcharged state by comparing an overcharging threshold value Vlim pre-stored in the internal memory with the cell voltage Vs of each of the cell voltage detecting units D1 to Dn in the determination process (overcharging determination process) of step S6, but determines that the battery assembly 1 is overcharged when the cell voltage Vs of at least one of the plurality of battery cells constituting the battery assembly 1 exceeds the overcharging threshold value.

On the other hand, when the determination of the above-described step S6 is “No,” the vehicle travel control device 6 performs the above-described normal traveling control (step S8) and iterates the process of the above-described step S1. That is, in the normal traveling control, the vehicle travel control device 6 sets the duty ratio of the PWM signal output to the inverter 4 exclusively according to the driver's driving instruction.

In addition, when the determination of the above-described step S3 is “Yes,” the vehicle travel control device 6 rewrites a content of the internal flag from the value indicating the normal traveling mode M1 to the value indicating the safe traveling mode M2, so that the travel mode is switched from the normal traveling mode M1 to the safe traveling mode M2 (step S9).

Further, when the determination of the above-described step S1 is the “safe traveling mode M2,” the vehicle travel control device 6 reads the SOC value stored in the internal memory in step S5 (step S10) and acquires the battery current Id supplied from the battery assembly 1 to the inverter 4 by acquiring the current detection signal from the ammeter 3 (step S11).

Then, the vehicle travel control device 6 acquires the cell temperatures of the cell voltage detecting units D1 to Dn by outputting a transmission instructing signal to the voltage detecting device 2 (step S12). Then, the vehicle travel control device 6 calculates an amount of change in the SOC value that changes in time series on the basis of the SOC value of the internal memory and the battery current Id and the cell temperature Ts, and calculates the true SOC value (remaining capacity) of the battery assembly 1 on the basis of the amount of change and the above-described SOC value (step S13).

That is, as illustrated in FIG. 3, the vehicle travel control device 6 calculates the SOC value of the battery assembly 1 on the basis of the cell voltages Vs of the cell voltage detecting units D1 to Dn in the normal traveling mode M1. On the other hand, because there is a problem with the reliability of the cell voltage Vs input from each of the cell voltage detecting units D1 to Dn in the safe traveling mode M2, the vehicle travel control device 6 calculates the SOC value of the battery assembly 1 on the basis of the SOC value Da (remaining capacity) of the battery assembly 1 at an abnormality occurrence time ta pre-stored in the internal memory, the battery current Id input from the ammeter 3, and the cell temperature Ts input from each of the cell voltage detecting units D1 to Dn.

In addition, the vehicle travel control device 6 determines overcharging of the battery assembly 1 on the basis of whether or not the cell voltage Vs of each of the cell voltage detecting units D1 to Dn exceeds the voltage upper limit value Vlim in the normal traveling mode M1. On the other hand, in the safe traveling mode M2, the vehicle travel control device 6 determines overcharging of the battery assembly 1 on the basis of whether or not the SOC value of the battery assembly 1 calculated on the basis of the SOC value Da, the battery current Id, and the cell temperature Ts described above exceeds an SOC upper limit value Dlim.

Then, the vehicle travel control device 6 performs safe traveling control on the basis of the above-described true SOC value (remaining capacity) that changes every moment according to the travel state of the vehicle and the driving instruction of the driver (step S14). That is, the vehicle travel control device 6 adds the true SOC value (remaining capacity) in the battery assembly 1 to the duty ratio of the PWM signal output to the inverter 4 and therefore allows traveling based on, for example, the driving instruction of the driver until the true SOC value (remaining capacity) is less than the preset lower limit value.

According to the vehicle traveling device A of the present embodiment, because the true SOC value of the battery assembly 1 is calculated on the basis of the SOC value Da of the battery assembly 1 at the abnormality occurrence time ta, the battery current Id input from the ammeter 3, and the cell temperatures Ts input from the cell voltage detecting units D1 to Dn in the safe traveling mode M2, the remaining capacity of the battery assembly 1 can be utilized to the utmost, so that it is possible to travel a longer distance than in the conventional technology when traveling with the vehicle using the remaining capacity of the battery assembly 1.

In addition, in the safe traveling mode M2, the vehicle travel control device 6 performs the overcharging determination process of the above-described step S6 after the process of the above-described step S14. In addition, in this case, the overcharging determination process, i.e., the overcharging determination process in the safe traveling mode M2, is limited to cell batteries that are not affected by disconnection determined to have occurred in the process of step S3 and it is determined whether or not overcharging is being reached.

It is to be noted that the present invention is not limited to the above-described embodiment, and for example, the following modified example is conceivable.

A true SOC value (remaining capacity) of the battery assembly 1 that changes every moment according to the travel state of the vehicle is calculated on the basis of the SOC value Da, the battery current Id, and the cell temperature Ts before the occurrence of the abnormality of the voltage detecting device 2 in the above-described embodiment, but the present invention is not limited thereto. For example, the true SOC value of the battery assembly 1 may be calculated by only the SOC value Da and the battery current Id before the occurrence of the abnormality of the voltage detecting device 2.

In addition, the true SOC value is calculated using the battery current Id and the cell temperature Ts in the safe traveling mode M2 in the above-described embodiment, but the SOC value may also be calculated using the battery current Id and the cell temperature Ts in the SOC calculation (step S4) in the normal traveling mode M1.

The case in which the voltage detecting device 2 for detecting the cell voltage Vs and the cell temperature Ts is provided as the battery monitoring device for monitoring the state of the battery assembly 1 has been described in the above-described embodiment, but the present invention is not limited thereto. For example, a battery monitoring device that detects only the cell voltage Vs or a battery monitoring device that detects an attribute value other than the cell voltage Vs and the cell temperature Ts may be adopted.

In addition, the cell temperature Td of each cell battery is detected in the above-described embodiment, but the present invention is not limited thereto. Instead of the cell temperature Td, the temperature of a predetermined portion of the battery assembly 1 may be detected as the representative temperature of the battery assembly 1, and the SOC value in the safe traveling mode M2 may be calculated using the representative temperature.

In addition, in this case, it is conceivable to provide a thermistor at a predetermined position on the battery assembly 1 and to provide a function of detecting the temperature of the battery assembly 1 on the basis of the output signal of this thermistor in the vehicle travel control device 6.

The case in which the occurrence of a disconnection of the voltage transmission line connecting each battery cell and each of the cell voltage detecting units D1 to Dn is determined as an abnormality of the voltage detecting device 2 has been described in the above-described embodiment, but the present invention is limited thereto. An abnormality of the voltage detecting device 2 other than the disconnection of the voltage transmission line may be determined.

What is claimed is:

1. A vehicle travel control device for controlling traveling of a vehicle by controlling a travel driving device that drives a traveling motor with power of a battery assembly,
wherein, when an abnormality has occurred in a battery monitoring device that monitors a state of the battery assembly, time-series changes of a remaining capacity are calculated on the basis of a remaining capacity of the battery assembly at a time of the occurrence of the abnormality and a battery current of the battery assembly after the occurrence of the abnormality, and the travel driving device is controlled on the basis of the remaining capacity obtained by the calculation.

2. The vehicle travel control device according to claim 1, wherein overcharging of the battery assembly is monitored on the basis of the remaining capacity of the battery assembly at the time of the occurrence of the abnormality and the battery current of the battery assembly after the occurrence of the abnormality, and the traveling of the vehicle is stopped before overcharging is reached.

3. The vehicle travel control device according to claim 1, wherein a temperature of the battery assembly is acquired and the travel driving device is controlled on the basis of the remaining capacity of the battery assembly at the time of the occurrence of the abnormality and the battery current of the battery assembly after the occurrence of the abnormality and the temperature of the battery assembly.

4. The vehicle travel control device according to claim 2, wherein a temperature of the battery assembly is acquired and the overcharging of the battery assembly is monitored on the basis of the remaining capacity of the battery assembly at the time of the occurrence of the abnormality and the battery current of the battery assembly after the occurrence of the abnormality and the temperature of the battery assembly.

5. A vehicle traveling device comprising:
a battery assembly;
a traveling motor configured to drive a vehicle;
a travel driving device configured to drive the traveling motor with power of the battery assembly;
a battery monitoring device configured to monitor a state of the battery assembly; and
the vehicle travel control device according to claim 1 configured to control the travel driving device.
